(19) United States
(12) Patent Application Publication
(10) Pub. No.: US 2012/0030049 A1
(43) Pub. Date: Feb. 2, 2012

(54) METHOD OF PROVIDING RENTAL AND PURCHASE MARKET FOR TEXTBOOKS

(75) Inventors: Brian Jacobs, Norwalk, CT (US); Geoffrey Katz, Norwalk, CT (US)

(73) Assignee: AKADEMOS, INC., Norwalk, CT (US)

(21) Appl. No.: 13/196,233

(22) Filed: Aug. 2, 2011

Related U.S. Application Data
(60) Provisional application No. 61/369,913, filed on Aug. 2, 2010.

(51) Int. Cl. G06Q 30/00

(52) U.S. Cl. 705/26.1

(57) ABSTRACT

A method for renting a textbook from a seller through a rental and purchase exchange system, the method including the steps of: a provider computer monitoring seller sale list prices of textbooks; the provider computer collecting information on a value of the textbook listed for sale by the seller; the provider computer determining if the textbook listed for sale is rentable; if the textbook is rentable, the provider computer determining a rental price for the textbook for a determined period term of time and adding the rental price to the seller sale listing of the textbook; the provider computer determining if the textbook has been rented to a current renter; if the textbook has been rented to a renter, the provider computer sending instructions to the seller to ship the textbook to the current renter directly. A computer system, and computer program product are also discussed.

### REFERENCE TO RELATED APPLICATIONS

This application claims one or more inventions which were disclosed in Provisional Application Number 61/369,913 filed Aug. 2, 2010, entitled “METHOD OF PROVIDING RENTAL AND PURCHASE MARKET FOR TEXTBOOKS”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of creating an on-line marketplace for renting goods. More particularly, the invention pertains to providing a rental and purchase market for textbooks.

2. Description of Related Art

Renting a textbook is an attractive option for a consumer that will use the textbook for an academic course, but will not want to keep the book at the end of the academic course. The consumer could buy a used textbook then sell the book at the end of the academic course, but doing so requires two separate transactions. However a renter of a textbook would only have to pay one fee and then return the textbook.

The textbook rental market is both highly dynamic and expanding. However, the current rental textbook markets operate behind a shroud, where the consumer is provided inadequate data to make an effective purchasing decision. A business renting a textbook provides two pieces of information to the consumer: 1) the rental price for a ‘used’ book and 2) a generic description. The actual textbook being rented is only described as ‘used’ and the consumer is not provided any further data regarding the actual textbook they will be receiving. Additionally, it is possible that the consumer could purchase the textbook for less than the cost to rent, as the consumer is not provided any information about the underlying cost of the textbook. This existing structure leads to a lack of transparency in the marketplace for rental textbooks, where the inefficiencies create an artificially high rental price, little specific information regarding the actual textbook and fewer purchasing options for the consumer.

A used textbook marketplace provider typically allows sellers to list used textbooks for sale, but does not allow an individual seller to offer a rental option. Even if it did, it is largely impractical for a typical used textbook seller to rent a textbook and track whether a renter returns the textbook timely. A seller is normally finished with the textbook and is seeking one transaction to provide some revenue in exchange for selling the textbook.

### SUMMARY OF THE INVENTION

A new method is provided wherein a provider allows a used book seller to list a book for sale including detailed information about its condition and a sales price. The provider then evaluates the value of the book and the typical rental price of the same book and can offer a rental price option for the book. For books offered for sale on a textbook marketplace, both the purchase price of the book and the rental price of the book are displayed. The provider offers to rent the book to the consumer at a price which is less than that textbook's sale price. If a renter selects the rental option, the provider buys the book from the seller and rents it to the buyer. The marketplace rental program inefficiencies are removed by providing the consumer with greater information about the book they will be renting and its underlying cost. Additionally, the details regarding the specific book (quality, particulars about condition, whether it includes peripherals, etc.) to be rented are included in the seller comments section of the website. The buyer is therefore provided with both the economic information to make the buy/rent decision and the exact quality of the book they will be renting.

### BRIEF DESCRIPTION OF THE DRAWINGS

FIG. 1 depicts a pictorial representation of a network of computers in which illustrative embodiments may be implemented.

FIG. 2 shows an example of a rental and purchase architecture system including a textbook exchange component.

FIG. 3 shows a flowchart of a method of obtaining a textbook for rental and providing a rental market for textbooks.

FIG. 4 shows a flowchart of a method of monitoring and tracking rental textbooks for returns.

FIG. 5a-5c shows a detailed chart of an implementation of the method of providing a rental and purchase market for textbooks within a total architecture system which includes a marketplace provider and a retail provider.

FIG. 6 illustrates internal and external components of a client computer and a server computer in which illustrative embodiments may be implemented.

### DETAILED DESCRIPTION OF THE INVENTION

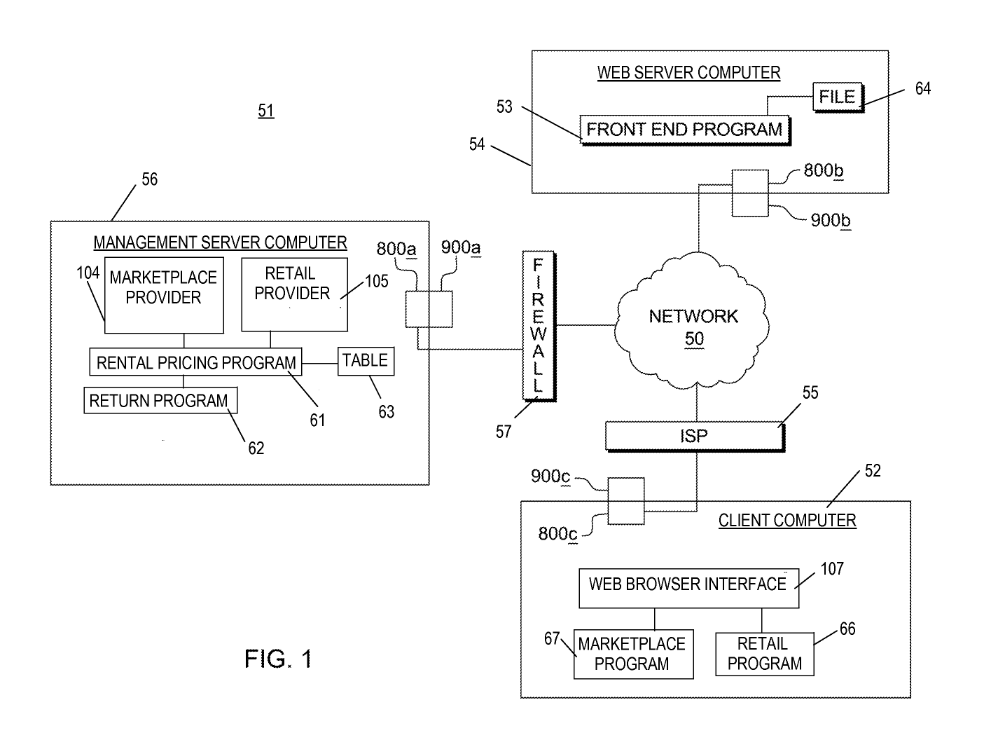

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

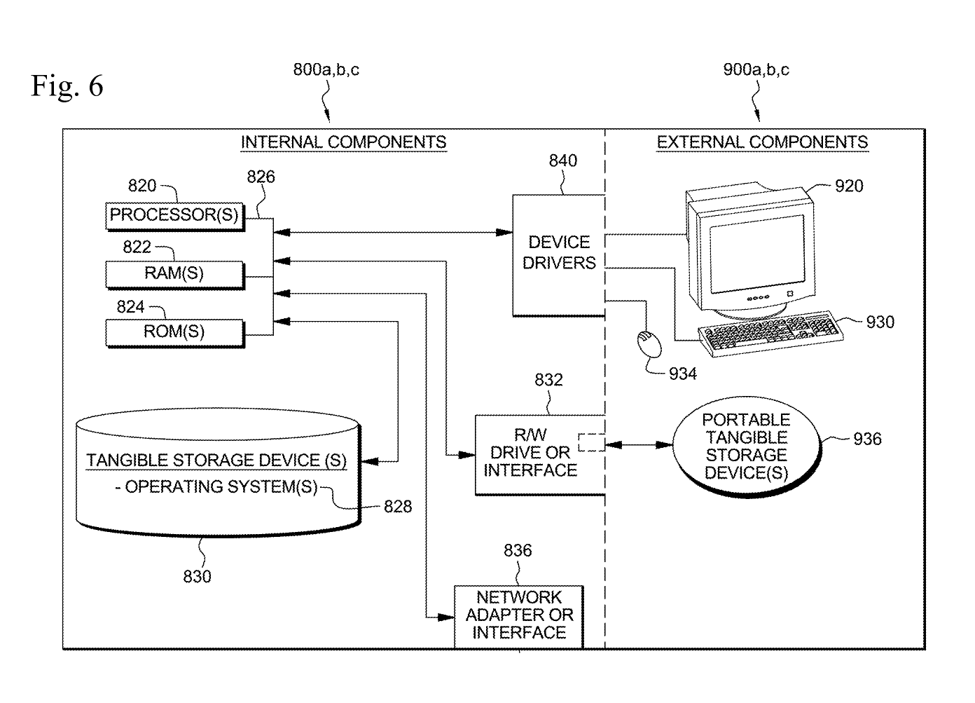

In the depicted example, server computers 54, 56 are connected to the network 50. Each of the server computers 54, 56 include respective sets of internal components 800a, 800b and external components 900a, 900b as illustrated in FIG. 6. Server computer 54 may for example be a web server in which a user may interact through external components 900b through a client computer 52. The web server computer 54 may have a front end process program 53 that accesses files 64. Server computer 56 may for example be a management server which is connected to the network 50 through a firewall 57. The management server computer 56 may be accessed through external components 900a. The management server 56 may have a marketplace provider 104 and a retail provider 105 which each access a rental pricing program 61 in connection with a table 63 and a return program 62.

In the depicted example, server 54 provides information, such as boot files, operating system images, and applications to a client computer 52. The client computer 52 may access the network 50 through an Internet service provider (ISP) 55 using a web browser interface 107. The web browser interface 107 is connected to a marketplace program 67 and a retail program 66. The client computer 52 includes internal components 800c and external components 900c illustrated in FIG. 6.

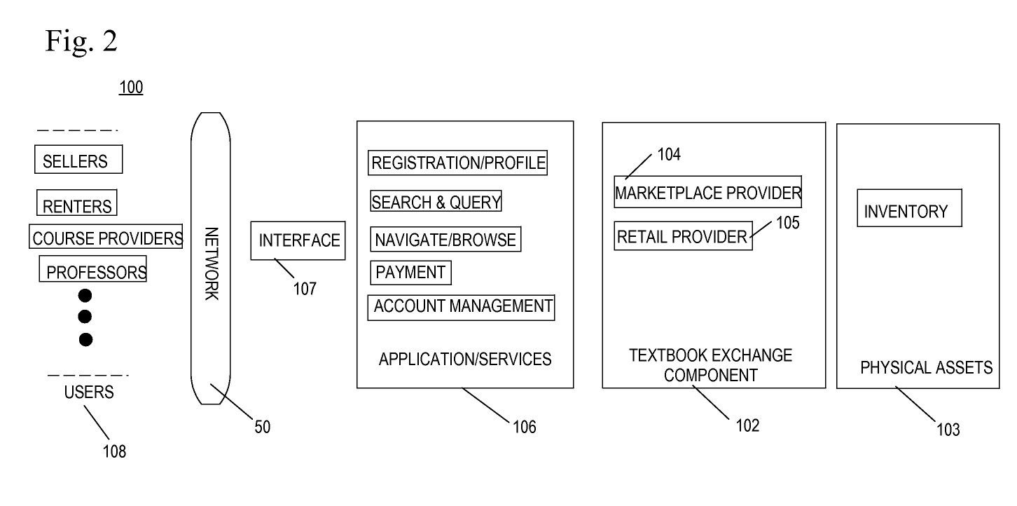

In other exemplary embodiments, network data processing system 51 may include additional client computers, storage devices, server computers, and other devices not shown. Client computer 52 includes a set of internal components 800a and a set of external components 900a, further illustrated in FIG. 6. Client computer 52 may be, for example, a mobile device, a cell phone, a personal digital assistant, a netbook, a laptop computer, a tablet computer, a desktop computer, or any other type of computing device. Client computer 52 may contain an interface 107. Through the interface 107, searches of the marketplace provider 104 component and retail provider 105 component may be performed and results of the searches may be displayed. Interface 107 may accept commands and data entry from a user 108 as shown in FIG. 2. Interface 107 can be, for example, a command line interface, a graphical user interface (GUI), or a web user interface (WUI) through which a user can access a retail program 66 or a marketplace program 67 on either client computer 52 or server computer 54. Server computer 54 includes a set of internal components 800b and a set of external components 900b illustrated in FIG. 6.

Program code, textbook exchange component 102 including the marketplace provider 104 and the retail provider 105, and programs such as marketplace program 67, retail program 66, rental pricing program 61, and return program 62 may also be located in network data processing system 51 and may be stored on at least one of one or more computer-readable tangible storage devices 830 shown in FIG. 6, on at least one of one or more portable computer-readable tangible storage devices 936 as shown in FIG. 6, on tangible storage device 53 connected to network 50, or downloaded to a data processing system or other device for use. For example, program code, textbook exchange component 102, and programs such as marketplace program 67, retail program 66, rental pricing program 61, and return program 62 may be stored on at least one of one or more tangible storage devices 830 on server computer 54 and downloaded to client computer 52 over network 50 for use on client computer 52. Alternatively, server computer 54 can be a web server, and the program code, textbook exchange component 102 including the marketplace provider 104 and the retail provider 105, and programs such as marketplace program 67, retail program 66, rental pricing program 61, and return program 62 may be stored on at least one of the one or more tangible storage devices 830 on server computer 54 and accessed on client computer 52. Marketplace program 67, retail program 66, rental pricing program 61, and return program 62 can be accessed on client computer 52 through interface 107. In other exemplary embodiments, the program code, textbook exchange component 102, and programs such as marketplace program 67, retail program 66, rental pricing program 61, and return program 62 may be stored on at least one of one or more computer-readable tangible storage devices 830 on client computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

For the discussion below, the term “marketplace” is used to describe a market where individual book owners/users can sell to each other on the proprietary website of the marketplace provider. The term “retail” is used to describe the sale and rental of books from the inventory of the owner of the website or retail provider. The term “book” is interchangeable with the term “textbook”. The term “high-bidder” is used to describe a consumer or buyer that through the marketplace provider has expressed interest and bid a specific amount for a book, which is greater than all other bids for the book. The term “used” refers to an object that has endured use.

FIG. 2 shows an example of a rental and purchase architecture system 100 including a textbook exchange component 102. The rental and purchase architecture system 100 may be part of the network data processing system 51 shown in FIG. 1.

The textbook rental and purchase architecture system 100 includes assets 103 such as textbooks and can include other assets not listed or shown in FIG. 2.

Applications and services 106 are provided to users 108 through network 50, using interface 107. Applications and services 106 may include registration and profile management; search and query, navigate/browse data assets, payment, and account management. Applications and services 106 are not limited to the assets or services shown in FIG. 2.

The textbook exchange component 102 includes a marketplace provider 104 and a retail provider 105. Each of these providers have access to programs such as the marketplace program 67, retail program 66, rental pricing program 61, and return program 62 as shown in FIG. 1. The components shown are not limited to those shown in FIG. 2.

Users 108 may include but are not limited to administrators, system architect, sellers, consumers/buyers, renters, professors and course providers.

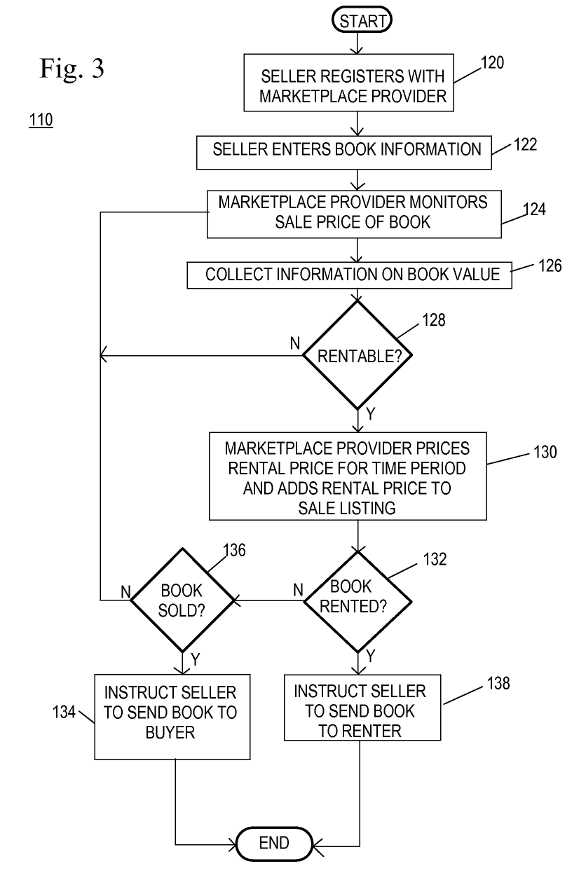

FIG. 3 shows an overview of a method of renting books, for example textbooks. The term “marketplace” is used to describe a market where individual book owners/users (sellers) can sell to each other on a proprietary website for example through the marketplace provider 104 and marketplace program 67.

A seller registers with the textbook exchange component 102 through a marketplace interface component 104 with a marketplace provider (step 120) and the seller enters book information, sale price, and other detailed information of the ‘used’ book with the marketplace provider (step 122). The seller registration information may include, for example seller description, seller performance and seller location. The detailed information of the book or textbook may include but is not limited to title, author, ISBN, specific condition of book, and location of the book.

The marketplace provider monitors the sale prices of ‘used’ books entered by the seller (step 124) and collects information on the book value of the ‘used’ book (step 126). The information collected regarding the book value of the ‘used’ book may be, but is not limited to current retail price, age of book, and current competitor pricing.

If the value of the ‘used’ book is not sufficient to support rental of the ‘used’ book to others (step 128), then return to monitoring the sale process of ‘used’ books entered by the seller (step 124).

If the value of the ‘used’ book is sufficient to support rental of the ‘used’ book (step 128), the marketplace provider 104 prices the rental price of the ‘used’ book for specific terms or lengths of time and adds the rental price to the listing of the book with the marketplace provider (step 130). It should be noted that the rental price of the ‘used’ book is less than the purchase price of the ‘used’ book.

The rental price may be set by setting a threshold amount to avoid a rental for books below a certain value. Assuming the book is above that value, then the marketplace rental price (MPRP) can be set to the lesser of:
1. $x.xx (random) below the most recent competitive rental price for the same ISBN; or
2. $x.xx or yy % below the marketplace sales price (MPSP) of the book (varying depending upon term of rental and other factors).

In addition, the marketplace provider may provide the book as rentable only if the derived MPRP is in excess of a threshold that can be fixed or a percentage of the MPSP. The term may also be a factor in determining MPRP.

If the book is rented by a renter through the marketplace provider (step 132), the seller is instructed by the marketplace provider to send the ‘used’ book to the renter (step 134).

If the book is not rented (step 132), but instead purchased by a consumer/buyer (step 136), the seller is instructed by the marketplace provider to send the book to the consumer (step 138).

It should be noted that either way, the seller is shipping to the buyer or renter and the rental option is transparent and effortless for the seller.

It should be noted that a similar process occurs for a retail rental, except that an institution sets the “seller” price and marketplace provider is the retail provider.

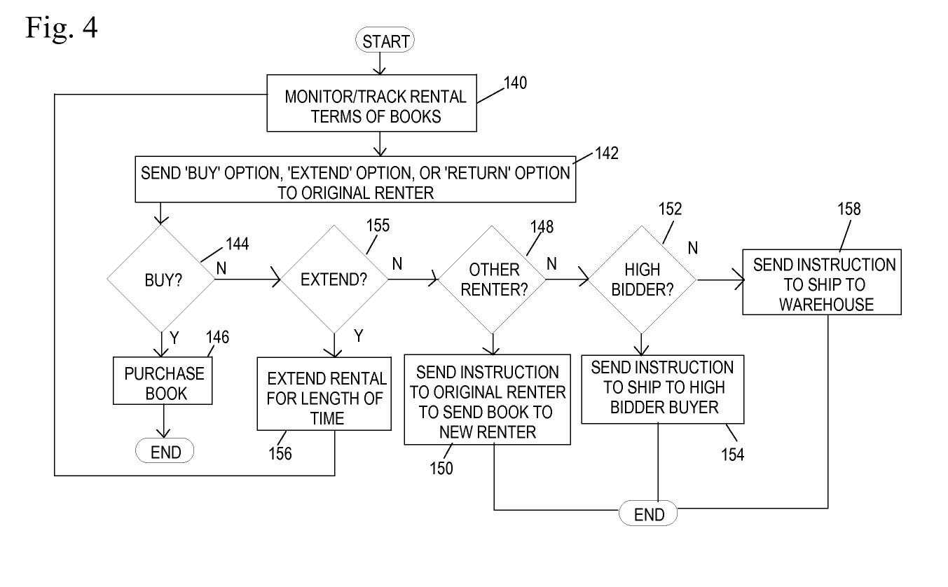

The rental of the ‘used’ textbooks is monitored by the marketplace provider 104 (step 140) as shown in FIG. 4. Once the time period of rental of the ‘used’ textbook is coming due, the current renter is sent an option to buy the ‘used’ textbook, extend the term of rental of the ‘used’ textbook, or to return the ‘used’ textbook (step 142).

If the current renter indicates to the marketplace provider 104 that they wish to buy the textbook (step 144), the current renter purchases the textbook (step 146).

If the current renter indicates to the marketplace provider 104 that they do not wish to buy the textbook (step 144), but wish to extend the rental term (step 155), the term is extended with the current renter through the marketplace provider 104 (step 156) and returns to the step of monitoring the rental by the marketplace provider 104 (step 140).

If the current renter indicates to the marketplace provider that they do not wish to buy the textbook (step 144), do not wish extend the rental term (step 155), and another renter for the ‘used’ textbook is present through the marketplace provider 104 (step 148), then the marketplace provider 104 sends instructions to the current renter to send the textbook to the new renter and return to step 140 of monitoring the rental by the marketplace provider 104.

If the current renter indicates to the marketplace provider that they do not wish to buy the textbook (step 144), do not wish extend the rental term (step 155), and another renter for the ‘used’ textbook is not present through the marketplace provider (step 148), and a high bidder is present through the marketplace provider (step 152), then the marketplace provider sends instructions to the current renter to send the textbook to the high bidder (step 154).

If the current renter indicates to the marketplace provider 104 that they do not wish to buy the textbook (step 144), do not wish extend the rental term (step 155), and another renter for the ‘used’ textbook is not present through the marketplace provider 104 (step 148), and a high bidder is not present through the marketplace provider 104 (step 152), then the marketplace provider 104 sends instructions to the current renter to send the textbook to the marketplace provider 104 (step 158).

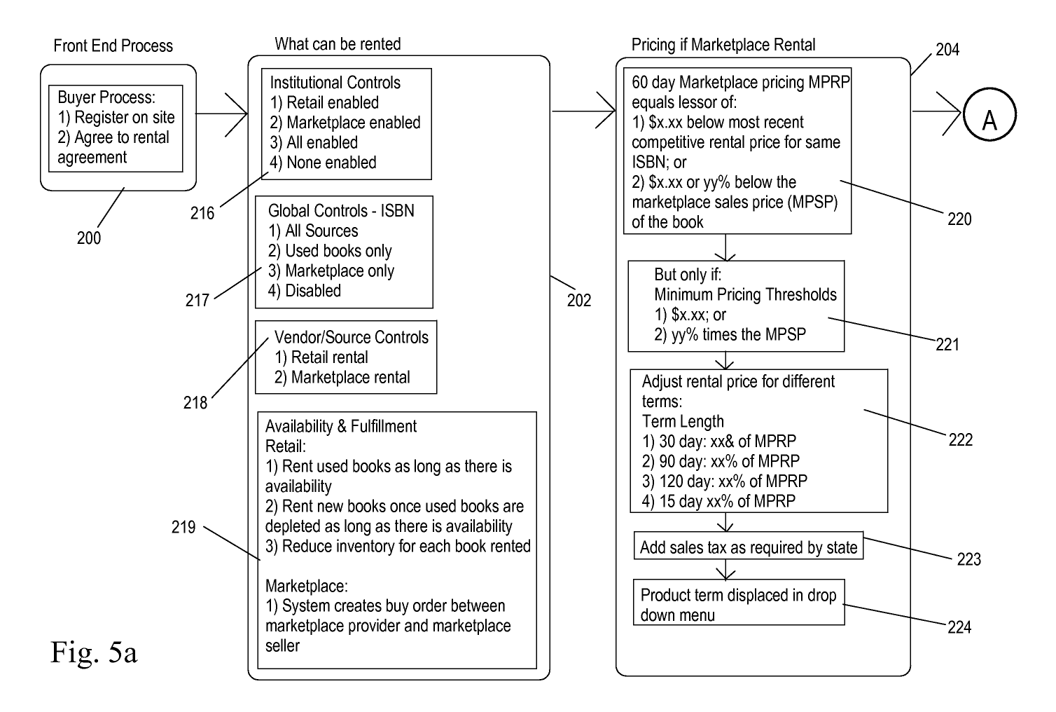

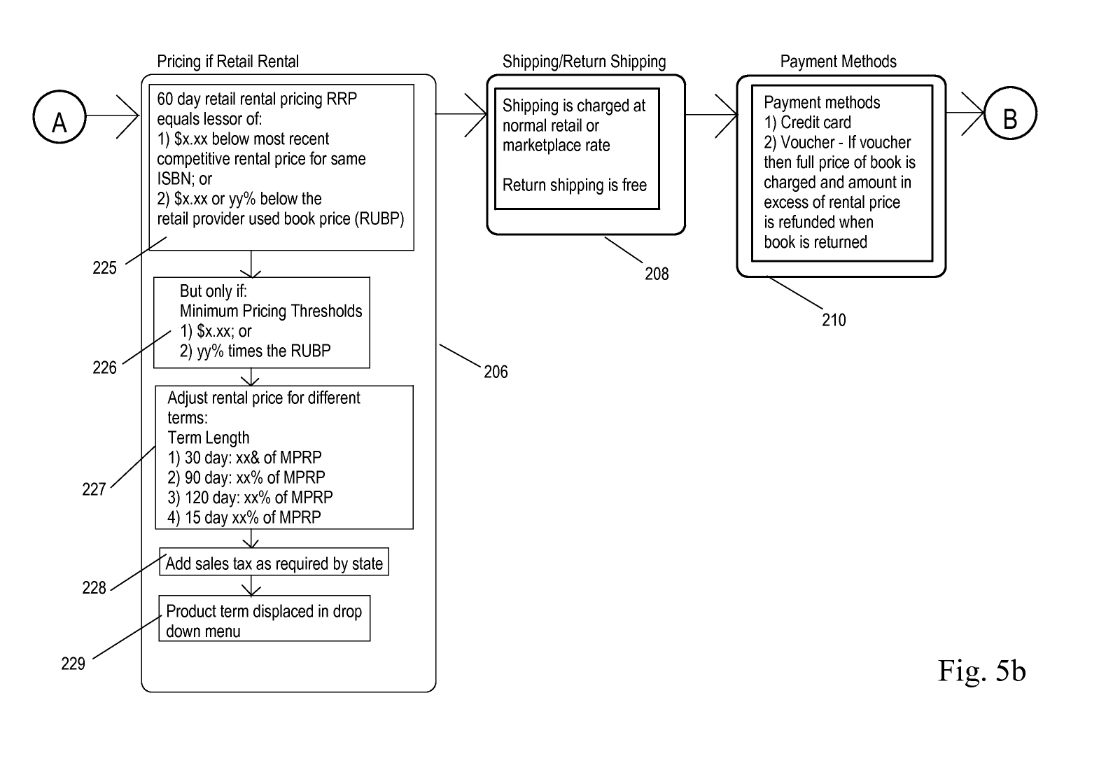

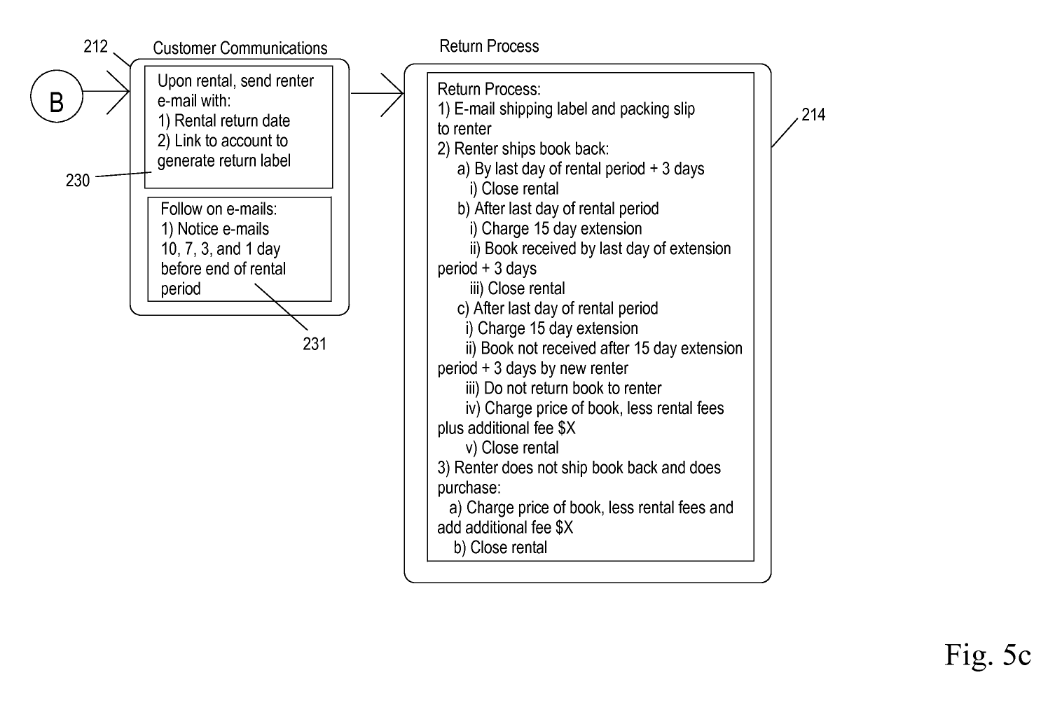

In implementing the method within a total marketplace system additional features can be added. FIGS. 5a-5b shows a detailed chart of implementation of the method of providing a rental and purchase market for textbooks within a rental and purchase architecture system 100 that includes a marketplace provider and a retail provider for an academic institution.

The term “marketplace” is used to describe a market where individual book owners/users can sell to each other on the proprietary website of the marketplace provider. The term “retail” is used to describe the sale and rental of books from the inventory of the owner of the website or retail provider.

As a front end process (200), a consumer registers with the a rental and purchase architecture system 100 and agrees to a rental agreement.

In an academic textbook market various academic institutions like to have control over the sale of used and new textbooks and what can be rented (202). The method can include controls that allow an academic institution to select from the following options/controls (216):
1. “Retail”: Enable retail-rentals only for this academic institution.
2. “Marketplace”: Enable marketplace-rentals only for this academic institution
3. “All”: Enable retail-rentals and marketplace-rentals for this academic institution.
4. “None”: Disable all rentals for this institution. NULL

In addition, the academic institution may choose to have the marketplace provider turn off rentals for a given academic institution/ISBN pair, in addition to the global rules. The marketplace provider can use institutional pricing or override table to disable a rental per ISBN, using zero price. The marketplace provider can also use a Hide-Low-Quantity rule that takes into account retail-rental availability.

The academic institution may also employ ISBN (Global) Controls (217) for a particular product. Assuming the rental option is enabled; textbook choices can be set for each type of sale:
1. All—rental is enabled for all sources (retail new, retail used and marketplace)
2. Used Only—retail rental is enabled for used books and marketplace only. New books are not counted towards rental availability.
3. Marketplace Only—retail rentals are disabled for both new and used books, but marketplace rentals are enabled.
4. Off—rental is disabled for all sources.

The marketplace provider may retain data for previously rentable books, so an “off” toggle is preferable to an empty set per ISBN. One of the fields in a table will be ‘enabled’ field so the provider (retail or marketplace) does not have to delete rental attachment after it has been created.

The academic institution may also choose whether the rental and purchase architecture system 100 uses a process to determine which vendors, sources, and/or books are eligible for rental (218). Besides the institutional controls, the system can specify various vendors that are or not eligible for the rental market. In a marketplace provider setting, it is also may be desirable to set a flag that specifies whether a seller is allowed to provide rentable books. This flag could be set with manual tools or by algorithms that make the determination based on past transactions or other factors. If the seller is set as “rentable” the above mentioned script will also enforce/create commerce rental records.

The rental price may be set by setting a threshold amount to avoid a rental for books below a certain value. In a marketplace provider rental, assuming the book is above that value, then the marketplace rental price (MPRP) can be set (220) to the lesser of:
1. $x.xx (random) below the most recent competitive rental price for the same ISBN; or
2. $x.xx or yy% below the marketplace sales price (MPSP) of the book (varying depending upon term of rental and other factors).

In addition, the marketplace provider may provide the book as rentable only if the derived MPRP is in excess of a threshold that can be fixed or a percentage of the MPSP (221). The term may also be a factor in determining MPRP (222).

In a retail rental provider, assuming the book is above that value, then the retail rental price (RRP) can be set (225) to the lesser of:
1. $x.xx (random) below the most recent competitive rental price for the same ISBN; or
2. $x.xx or yy % below the retail used book price (RUBP) of the book (varying depending upon term of rental and other factors).

In addition, the retail provider may provide the book as rentable only if the derived RRP is in excess of a threshold that can be fixed or a percentage of the RUBP (226). The term may also be a factor in determining RRP (227).

Rental orders use a normal product table entries for the items they are using: retail new/used or marketplace. For example, the normal product table entries may be, but are not limited to commerce/rental product_id; enabled customer_id, and price—which is based on a set of rules. Typical information that may be stored in a commerce order rental table is, but not limited to:
1 Term chosen
2 Extension chosen
3 Rental return date—This date can be changed by other processes (see Return section), so should not be a derived value.
4 Original Listing Price—If retail new or retail used, use List Price—If marketplace, use marketplace sale price
5 Original Rental Price, with extensions (in the case of gift code payment, the unit-price will be the full amount, not the rental amount) and an Actual order_line unit_price table can be used.

With regard to rental term lengths it is desirable to offer fixed terms (calendar days—term starts on delivery date) for specific days (e.g. 30-day, 60-day, 90-day, 120-day) and then offer a global 15-day add-on, that can be applied to any term (e.g. 30 becomes 45, etc.) (224, 229).

The a rental and purchase architecture system 100 can include a tax collection system (223, 228). In retail provider rental transaction, generally tax needs to be collected according to current guidelines, but in marketplace provider rentals, the taxes may be the responsibility of the seller. In some cases the sales price is not known to the renter because they paid the rental price rather than the sales price paid by the marketplace provider and the renter's price is not a straight line function of the selling price.

Shipping will be typically charged at the normal retail or marketplace rates (208). The retail or marketplace provider can incorporate free shipping and incentives as it normally would.

A provider can set its own priority based on its own preferences or those of an institution served by the provider (219). For example, the system might set a preference for retail rental to rent used books first, then new books only if retail-used is depleted and the ISBN has a rental control set to allow such a rental.

One consideration in allowing transactions in multiple types of markets is that the available quantity of a book should be set to be the quantity of the specific item (new, used, marketplace) based on a particular source. A buyer should only be allowed to exhaust a single source to depletion for a given rental. For example, if a consumer adds qty 5 to his cart for a rental based on used stock of 5, he cannot increase it further even if there are eligible marketplace rentals or new book rentals available. If the consumer wants to buy additional copies the consumer will need to initiate a different transaction since it is in fact a different transaction with a different source. Once the transaction is entered, the actual new/used book product lines are decremented to show the change in availability and stored with the order.

If a textbook is sold by the provider, the system generates a plain-sheet label along with the pick, which specifies rental instructions for the buyer and is included in the box with the pack-sheet. If a textbook sale is to be a marketplace rental, the system creates an order between the seller and the buyer as normal.

Prior to closing the transaction, the system displays a rental agreement to the renter during checkout (similar to what's typically done for a marketplace agreement). The renter must check off “I have read . . . ” before proceeding. In addition, the system will require a user account to be created if not already done so (200). Payment methods are similar for other internet business transactions: credit card, gift card, voucher, coupon code, ACH transfer, monetary transaction from a third party payor (e.g. PayPal® payments), etc . . . (210).

While the system could be set up to trust that a renter will return the book, this leads to collections issues for small amounts of money that are not worth chasing. If a credit card is used, the rental agreement might provide for an additional charge if the book is not timely returned (214). Alternatively, the system could charge the renter with the full costs of the book and offer to refund the difference between the purchase cost and rental cost upon return of the book. For example, if a gift voucher was used, but no credit card information is available, the system could charge the full price of the book against the gift voucher, then issue a new gift voucher when the book is returned.

When the renter is selecting a rental option, from the retail provider or the marketplace provider, a dropdown menu next to the add-to-cart button is available with the rental term length (224, 229). If the default term is 60 days, then a check-box under the dropdown with the text: “Add 15 days” can be included. It will be helpful to display the calculated return day, updated based on the form selections (triggered on change). The renter would be allowed to make an adjustment in the shopping cart as well. The receipt, e-mail confirmation, order tracking, and preferably shipping materials should indicate a rental and the return date. The receipt can also indicate the condition of the book.

The status of the rental should be tracked as discussed in FIG. 4 and in FIG. 5c (214). It may be desirable to communicate with the renter to confirm that he/she will be returning the book timely, or allow the renter to purchase a rental extension or the book outright. If the book is not returned, then the difference between the rental price and purchase price can be charged to the renter. If a gift voucher was used, then no settlement amount is necessary because the customer was already charged the full amount at checkout. If a credit card was used, it can be charged immediately. This often has to be a manual process by employee with the valid card encryption key, but can be done in batches as often as needed. If there is a credit card error, the system can transfer information to a collections protocol system. Either the book is returned, transferred to a new customer or kept by the renter. The new customer may be a renter or a high-bidder. In general, the rental is closed even if there is a payment error. If payment was made using a gift voucher, the system can insert a refund line in the amount of the difference between the charged price and the rental price once the book is returned.

Assuming the renter indicates he/she will be returning the book, the system can place the book up for sale/rent. If the system sells or rents the book to a new customer, then the shipping label can be set to send the book to the new customer, thus avoiding two shipping charges.

The system can send the current renter emails with the rental return date and a link to their account (order detail) for generating a return label (230). Reminders can be sent on a schedule, e.g. 10-day, 7-day, 3-day and 1-day before the rental is due (231). All emails except the first one check for label generation: If a label was generated, this system can provide a confirmation, “Thank you for creating your label! You must also make sure that your order is shipped before your rental due date . . . ” If label was not yet generated: “We see that you have not generated your return label . . . ” If the return label has not been generated by the return date, the system can automatically charge the buyer a 15-day extension, and update the stored return date (original return date+15 days). The system can include a grace period, e.g. 3 days, and factoring in the 3-day grace, buyer will be 12 days out from the new return, and 2 days out from the reminder email system described above. Should the current renter not return the book, the system could email the customer asking them to contact customer support for assistance

As a practical matter, such a system will include a condition or wrong book dispute protocol. Disputes can be resolved through the provider's customer service. The provider will be able to pull up the rental return order, which can be accessed as any other order. The system can place an order “on hold” to freeze it while investigating disputes and can provide for instituting charges against the buyer and seller as appropriate after resolution.

FIG. 6 illustrates internal and external components of client computer 52 and server computers 54, 56 in which illustrative embodiments may be implemented. In FIG. 6, client computer 52 and server computers 54, 56 include respective sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and marketplace program 67, retail program 66, rental pricing program 61, and return program 62 are stored on one or more of the computer-readable tangible storage devices 830 for execution by one or more of the processors 820 via one or more of the RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. Marketplace program 67, retail program 66, rental pricing program 61, and return program 62 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. Marketplace program 67, retail program 66, rental pricing program 61, and return program 62 can be downloaded to computer 52 and server computers 54, 56 from an external computer via a network (for example, the Internet, a local area network or other, wide area network) and network adapter or interface 836. From the network adapter or interface 836, marketplace program 67, retail program 66, rental pricing program 61, and return program 62 are loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 940. Each of the sets of internal components 800a, 800b, 800c also includes device drivers 840 to interface to computer display monitor 920, keyboard 930 and computer mouse 940. The device drivers 840, R/W drive or interface 832 and network adapter or interface 836 comprise hardware and software (stored in storage device 830 and/or ROM 824).

Marketplace program 67, retail program 66, rental pricing program 61, and return program 62 can be written in various programming languages including low-level, high-level, object-oriented or non object-oriented languages. Alternatively, the functions of search model program 66 can be implemented in whole or in part by computer circuits and other hardware (not shown).

Based on the foregoing, a computer system, method and program product have been disclosed for renting a textbook from a seller through a rental and purchase architecture system. However, numerous modifications and substitutions can be made without deviating from the scope of the present invention. Therefore, the present invention has been disclosed by way of example and not limitation.

What is claimed is:

1. A method for renting a textbook from a seller through a rental and purchase exchange system, the method comprising the steps of:
a provider computer monitoring seller sale list prices of textbooks;
the provider computer collecting information on a value of the textbook listed for sale by the seller;
the provider computer determining if the textbook listed for sale is rentable;
if the textbook is rentable, the provider computer determining a rental price for the textbook for a determined period term of time and adding the rental price to the seller sale listing of the textbook;
the provider computer determining if the textbook has been rented to a current renter;
if the textbook has been rented to a renter, the provider computer sending instructions to the seller to ship the textbook to the current renter directly.

2. The method of claim 1, wherein the provider computer determining if the textbook listed for sale is rentable further comprises the steps of:
determining a threshold amount and comparing the value of the textbook to the threshold amount;
if the value of the book is greater than the threshold amount, setting the rental price to the lesser of:
an amount below a most recent competitor rental price for the same textbook; or
an amount or percent below provider sale price.

3. The method of claim 1, wherein if the provider computer determines that the textbook has not been rented to a current renter and has been sold to a buyer, the provider computer sending instructions to the seller to ship the textbook directly to the buyer.

4. The method of claim 1, wherein if the provider computer determines that the textbook listed for sale is not rentable returning to the provider monitoring seller sale list prices of textbooks.

5. The method of claim 1, wherein after the provider computer sending instructions to the seller to ship the textbook to the current renter directly, the provider computer monitoring and tracking the rental comprising the steps of:
the provider computer tracking the term of time of the rental of the textbook;
the provider computer sending the current renter an option to buy the textbook, extend the term of time of rental of the textbook, or return the textbook;
the provider computer receiving input from the current buyer to return the textbook;
the provider computer determining if the textbook has been rented by a new renter; and
if the textbook has been rented by the new renter, the provider sending instructions to the current renter to ship the textbook to the new renter directly.

6. The method of claim 5, wherein if the provider computer determines the textbook has not been rented by a new renter; and the provider determines that the textbook has not been purchased by a high bidder, the provider sending instructions to the current renter to ship the textbook to an inventory control of the provider.

7. The method of claim 5, wherein if the provider computer determines the textbook has not been rented by a new renter; and the provider determines that the textbook has been purchased by a high bidder, the provider sending instructions to the current renter to ship the textbook to the high bidder directly.

8. The method of claim 1, wherein the provider is marketplace provider.

9. The method of claim 1, wherein the provider is a retail provider and the seller is an institution.

10. A computer program product comprising one or more computer-readable, tangible storage devices and computer-readable program instructions which are stored on the one or more storage devices and when executed by one or more processors perform the method of claim 1.

11. A computer system comprising one or more processors, one or more computer-readable memories, one or more computer-readable, tangible storage devices and program instructions, which are stored on the one or more storage devices for execution by the one or more processor via the one or more memories and when executed by the one or more processors implement all the steps of claim 1.

13. A computer program product for renting a textbook from a seller through a rental and purchase exchange system, the computer program product comprising:
one or more computer-readable, tangible storage devices;
program instructions, stored one at least one of the one or more storage devices to monitor seller sale list prices of textbooks;
program instructions, stored one at least one of the one or more storage devices to collect information on a value of the textbook listed for sale by the seller;
program instructions, stored one at least one of the one or more storage devices to determine if the textbook listed for sale is rentable; and
if the textbook is rentable, program instructions, stored one at least one of the one or more storage devices to determine a rental price for the textbook for a determined period term of time and adding the rental price to the seller sale listing of the textbook;
program instructions, stored one at least one of the one or more storage devices to determine if the textbook has been rented to a current renter;
if the textbook has been rented to a renter, program instructions, stored one at least one of the one or more storage devices to send instructions to the seller to ship the textbook to the current renter directly.

14. The computer program product of claim 13, wherein the program instructions to determine if the textbook listed for sale is rentable further comprises program instructions, stored on at least one of the one or more storage devices of:
determining a threshold amount and comparing the value of the textbook to the threshold amount;
if the value of the book is greater than the threshold amount, setting the rental price to the lesser of:
an amount below a most recent competitor rental price for the same textbook; or
an amount or percent below provider sale price.

15. The computer program product of claim 13, wherein if the program instructions determine that the textbook has not been rented to a current renter and has been sold to a buyer, program instructions to send instructions to the seller to ship the textbook directly to the buyer.

16. The computer program product of claim 13, wherein if the program instructions determine that the textbook listed for sale is not rentable, program instructions to return program instructions to monitor the seller sale list prices of textbooks.

17. The computer program product of claim 13, wherein after the program instructions to send instructions to the seller to ship the textbook to the current renter directly, further comprising program instructions to monitor and track the rental comprising:
program instructions, stored one at least one of the one or more storage devices to track the term of time of the rental of the textbook;
program instructions, stored one at least one of the one or more storage devices to send the current renter an option to buy the textbook, extend the term of time of rental of the textbook, or return the textbook;
program instructions, stored one at least one of the one or more storage devices to receive input from the current buyer to return the textbook;
program instructions, stored one at least one of the one or more storage devices to determine if the textbook has been rented by a new renter; and
if the textbook has been rented by the new renter, the provider sending instructions to the current renter to ship the textbook to the new renter directly.

18. The computer program product of claim 17, wherein if the program instructions determine the textbook has not been rented by a new renter; and that the textbook has not been purchased by a high bidder, program instructions to send instructions to the current renter to ship the textbook to an inventory control of the provider.

19. The computer program product of claim 17, wherein if the program instructions determine the textbook has not been rented by a new renter; and that the textbook has been purchased by a high bidder, program instructions to send instructions to the current renter to ship the textbook to the high bidder directly.

20. A computer system for renting a textbook from a seller through a rental and purchase exchange system, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories to monitor seller sale list prices of textbooks;
program instructions, stored on at least one of the one or more storage devices for execution by at least one of the one or more processors via at least one of the one or more memories to collect information on a value of the textbook listed for sale by the seller;
program instructions, stored on at least one of the one or more storage devices for execution by at least one of the one or more processors via at least one of the one or more memories to determine if the textbook listed for sale is rentable; and
if the textbook is rentable, program instructions, stored one at least one of the one or more storage devices to determine a rental price for the textbook for a determined period term of time and adding the rental price to the seller sale listing of the textbook;
program instructions, stored on at least one of the one or more storage devices for execution by at least one of the one or more processors via at least one of the one or more memories to determine if the textbook has been rented to a current renter;
if the textbook has been rented to a renter, program instructions, stored one at least one of the one or more storage devices to send instructions to the seller to ship the textbook to the current renter directly.

21. The computer system of claim 20, wherein the program instructions, stored on at least one of the one or more storage devices for execution by at least one of the one or more processors via at least one of the one or more memories to determine if the textbook listed for sale is rentable further comprises program instructions, stored on at least one of the one or more storage devices for execution by at least one of the one or more processors via at least one of the one or more memories of:
determining a threshold amount and comparing the value of the textbook to the threshold amount;
if the value of the book is greater than the threshold amount, setting the rental price to the lesser of:
an amount below a most recent competitor rental price for the same textbook; or
an amount or percent below provider sale price.

23. The computer system of claim 20, wherein if the program instructions determine that the textbook has not been rented to a current renter and has been sold to a buyer, program instructions to send instructions to the seller to ship the textbook directly to the buyer.

24. The computer system of claim 20, wherein if the program instructions determine that the textbook listed for sale is not rentable, program instructions to return program instructions to monitor the seller sale list prices of textbooks.

25. The computer system of claim 20, wherein after the program instructions stored on at least one of the one or more storage devices for execution by at least one of the one or more processors via at least one of the one or more memories to send instructions to the seller to ship the textbook to the current renter directly, further comprising program instructions, stored on at least one of the one or more storage devices for execution by at least one of the one or more processors via at least one of the one or more memories to monitor and track the rental comprising:
program instructions, stored on at least one of the one or more storage devices for execution by at least one of the one or more processors via at least one of the one or more memories to track the term of time of the rental of the textbook;
program instructions, stored on at least one of the one or more storage devices for execution by at least one of the one or more processors via at least one of the one or more memories to send the current renter an option to buy the textbook, extend the term of time of rental of the textbook, or return the textbook;
program instructions, stored on at least one of the one or more storage devices for execution by at least one of the one or more processors via at least one of the one or more memories to receive input from the current buyer to return the textbook;
program instructions, stored on at least one of the one or more storage devices for execution by at least one of the one or more processors via at least one of the one or more memories to determine if the textbook has been rented by a new renter; and
if the textbook has been rented by the new renter, the provider sending instructions to the current renter to ship the textbook to the new renter directly.

26. The computer system of claim 25, wherein if the program instructions determine the textbook has not been rented by a new renter; and that the textbook has not been purchased by a high bidder, program instructions stored on at least one of the one or more storage devices for execution by at least one of the one or more processors via at least one of the one or more memories to send instructions to the current renter to ship the textbook to an inventory control of the provider.

27. The computer system of claim 25, wherein if the program instructions determine the textbook has not been rented by a new renter; and that the textbook has been purchased by a high bidder, program instructions stored on at least one of the one or more storage devices for execution by at least one of the one or more processors via at least one of the one or more memories to send instructions to the current renter to ship the textbook to the high bidder directly.
